(19) United States
(12) Patent Application Publication
(10) Pub. No.: US 2019/0012651 A1
(43) Pub. Date: Jan. 10, 2019

(54) Process and system in which the user can either provide or receive vehicle transportation with other users

(71) Applicant: Jason Roberts, Oklahoma City, OK (US)

(72) Inventor: Jason Roberts, Oklahoma City, OK (US)

(21) Appl. No.: 15/643,746

(22) Filed: Jul. 7, 2017

(51) Int. Cl. G06Q 20/32; G06Q 30/02

(52) U.S. Cl. CPC G06Q 20/322; G06Q 2240/00; G06Q 30/0282

(57) ABSTRACT

This current invention is a system and app is aimed to make it easy for people to secure affordable private ride services within a service area. Service user can request a ride, view drivers' profiles, pay for the ride through the app, and review the driver when the ride is complete. Drivers can accept or reject fares and review riders when the ride is complete.

### CROSS-REFERENCES TO RELATED APPLICATIONS (IF ANY)

None

### BACKGROUND

### 1. Field of the Invention

The present invention relates to a process to match drivers and passengers for private hire ride services.

### 2. Description of Prior Art

Currently, the private ride service app market is dominated by Uber. Uber connects drivers and riders together, based on factors such as current location, destination, and fare. Uber focuses on serving high density areas with a steady demand for rides, and generates revenue based on a percentage of fares. There needs to be more control and information exchange than what is offered in the current environment.

There is still room for improvement in the art.

### SUMMARY OF THE INVENTION

The current invention is system and application in which the users can find or provide private ride services. Each user has a profile, and both riders and drivers can reject a fare and leave a review after. This current invention will include each user feature separate from the other or combined.

The system, in the preferred embodiment, would work like a smartphone application, this product would be available through the respective marketplace for smartphones.

The process would be that a user would register and login as either a rider or a driver.

A driver will wait for a fare request. The driver will view the profile of user making the request, and either select or reject the request. If the fare is selected, the driver picks up the rider and takes them to the desired destination. When the fare is complete, the driver can review a rider.

A rider will request a fare from a beginning location to a destination. When a driver has accepted the fare, the rider will see the driver's profile and may choose to refuse the driver. When a ride is approved, the rider is picked up and taken to the destination. The rider pays for the fare through the app, using a credit card or other electronic means. The rider can pre-pay a tip or choose to tip based on individual ride service. After the ride is complete, the rider can review the driver.

If a driver or a rider receives a significant amount of negative reviews, the user can be blocked from future use of the app.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 shows a sample of a login screen;

FIG. 3 shows registration;

FIG. 4 shows the screen to select “Driver” or “Passenger”;

FIG. 5 shows driver registration screen—mailing address;

FIG. 6 shows driver registration screen—Driver License information;

FIG. 7 shows driver registration screen—Social Security and date of birth;

FIG. 8 shows driver registration screen—background check authorization;

FIG. 9 shows driver registration screen—Insurance data;

FIG. 10 shows driver registration screen—provide insurance card;

FIG. 11 shows driver registration screen—further instructions;

FIG. 12 shows driver registration screen—Terms & Conditions;

FIG. 13 shows passenger payment set up—Credit Card data;

FIG. 14 shows passenger payment set up—payment set up;

FIG. 15 shows passenger payment set up—with menu;

FIG. 16 shows passenger payment set up—Credit Card;

FIG. 17 shows passenger payment set up using an on-line payment service;

FIG. 18 shows Driver settings;

FIG. 19 shows Passenger settings;

FIG. 20 shows Notifications;

FIG. 21 shows History;

FIG. 22 shows About Us;

FIG. 23 shows passenger Payment Choice screen;

FIG. 24 shows the passenger Request Pick Up;

FIG. 25 shows the passenger pick up confirmation;

FIG. 26 shows passenger destination selection screen—previous rides;

FIG. 27 shows passenger destination selection screen—new destination;

FIG. 28 shows the fare estimate and option to set gratuity before riding;

FIG. 29 shows the post-ride gratuity;

FIG. 30 shows the option to give user reviews;

FIG. 31 shows driver activity page;

FIG. 32 shows the page for a driver to join Club Level;

FIG. 33 shows a Driver Profile page;

FIG. 34 shows the driver's vehicle information input page;

FIG. 35 shows the base map with the option for driver to be active;

FIG. 36 shows alert for a ride request;

FIG. 37 shows passenger pick up map;

FIG. 38 shows driving map;

FIG. 39 shows fare meter;

FIG. 40 shows the Passenger logic flow; and

FIG. 41 shows the Driver logic flow.

### DESCRIPTION OF THE PREFERRED EMBODIMENT

There are a number of significant design features and improvements incorporated within the invention.

The current invention is a system and application that would connect drivers and riders for efficient private ride services through a greater service region.

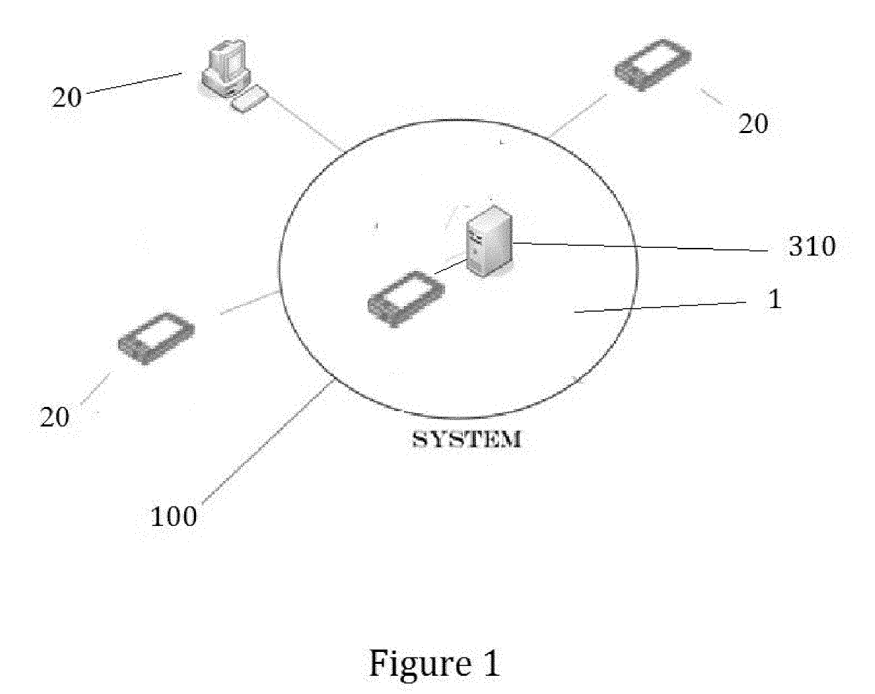

FIG. 1 displays the preferred embodiment of the system architecture 1 accessed through an Internet, Intranet and/or Wireless network 500. However, the system could be implemented on a device-to-device or client/server architecture as well.

In FIG. 1, the system 1 is accessed from a user's computing device 20 through a web browser over HTTP and/or HTTPS protocols 500 or wireless network or cell phone to cell phone connection. A computing device 20, such as a cell phone, that can access the system 1 must have some version of a CPU, CPU memory, local hard disk, keyboard/keypad/input and display unit. The computing device 20 can be any desktop, laptop, tablet, smart phone or general purpose computing device with an appropriate amount of memory suitable for this purpose and an active connection to the Internet 500. Computing devices like this are well known in the art and are not pertinent to the invention.

The system 1, data and processing code can reside in the non-transitory memory 310 of the one or more computing devices. The system 1 in the preferred embodiment would be written to act like a smart phone application (app) where the different apps can communicate with each. The system 1 may work with a central server as shown in FIG. 1 or in parallel which each computing device 10 or smartphone communicating with others within the system 1.

The system 1, data and processing code can reside in the non-transitory memory 310 of the one or more computing devices. The system 1 in the preferred embodiment would be written to act like a smart phone application (app).

This current invention is a system 1 and app is aimed to make it easy for riders and independent ride service providers to connect in service areas. The service would allow riders to post a fare, and both rider and driver to view each other's profile for an opportunity to accept or reject the fare. All fares are paid electronically. After each fare, users are able to write a review of one another. The system 1 will include each user feature separate from the other or combined.

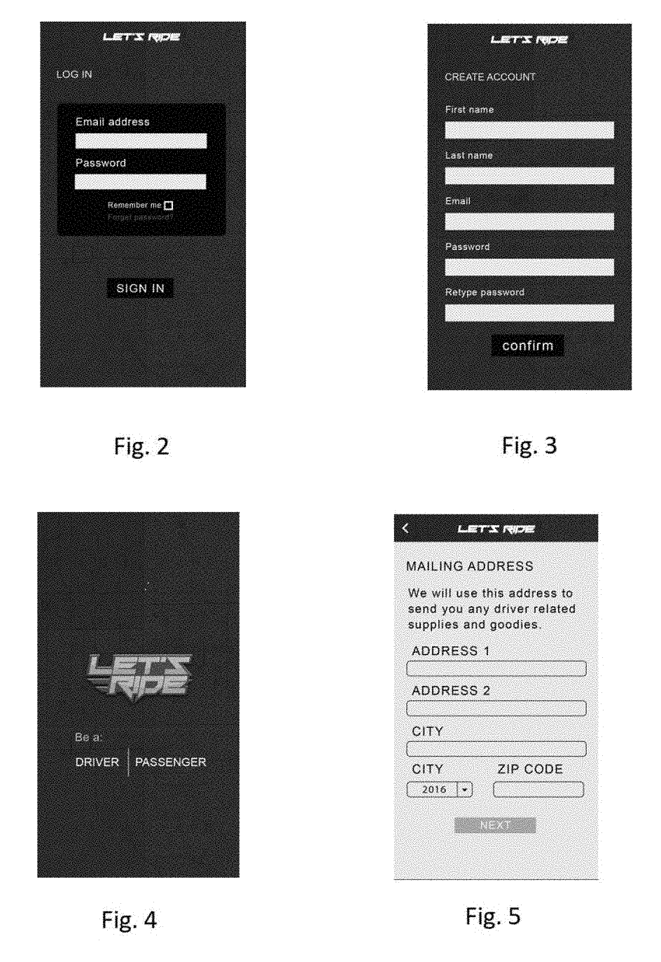

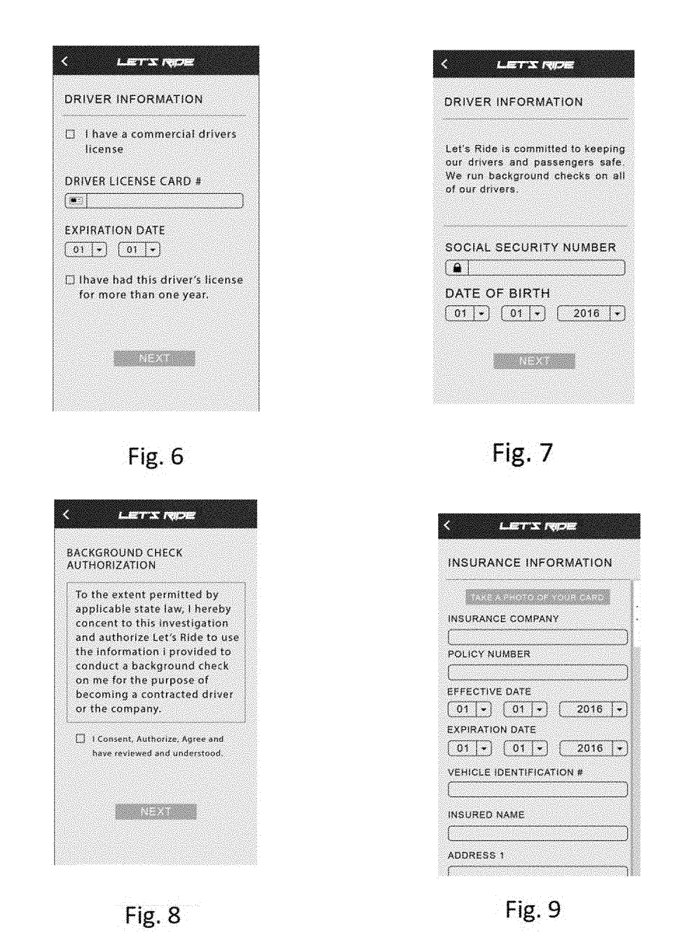

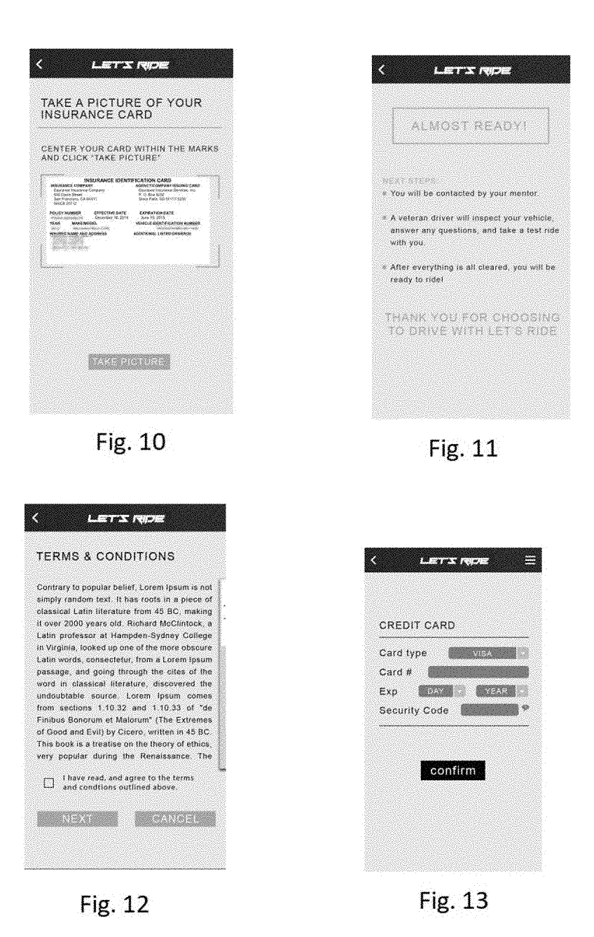

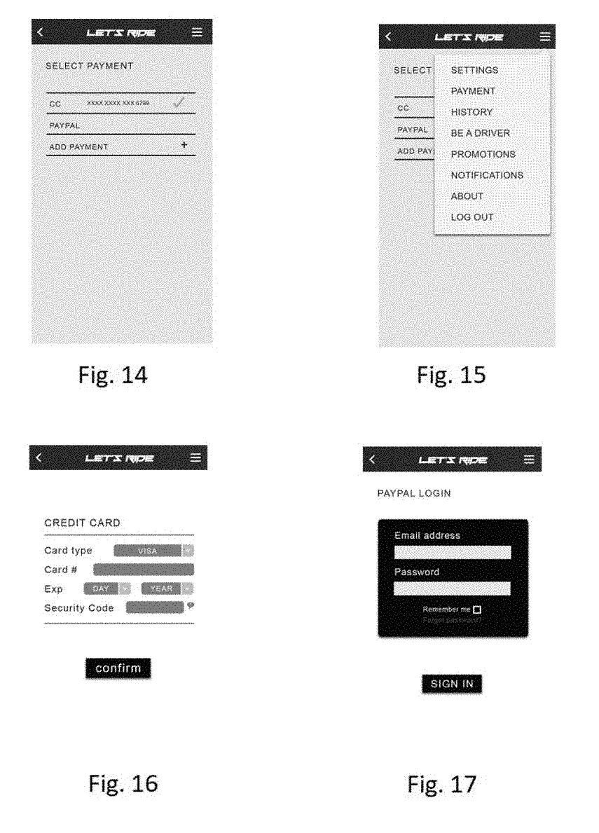

The users would sign-in directly or using social logins as shown in FIG. 2 with the user registering the app as in FIG. 3. The user would select to register as either a driver or a passenger, as in FIG. 4. Driver registration may require additional information, as in FIGS. 5-12. Passengers must set up a payment form, as in FIGS. 13-17.

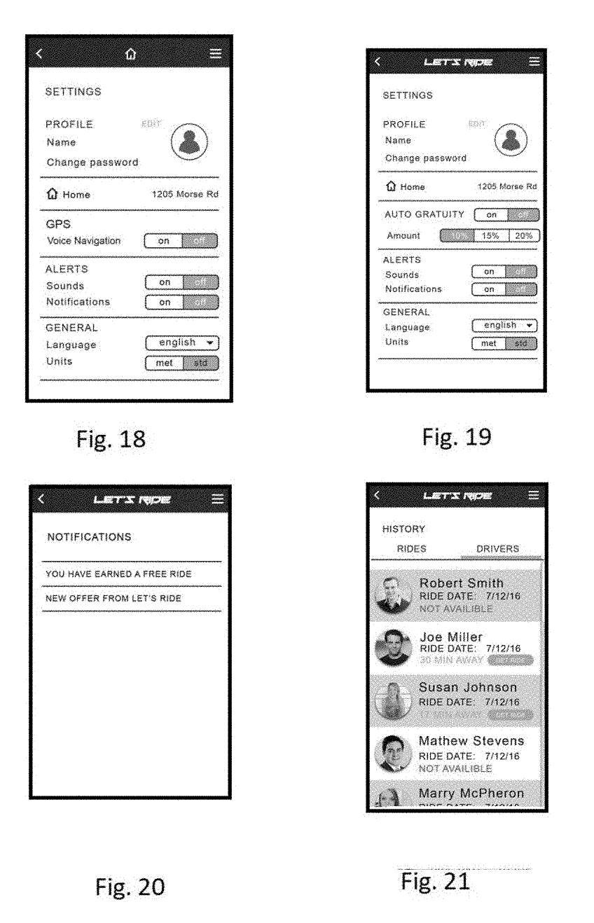

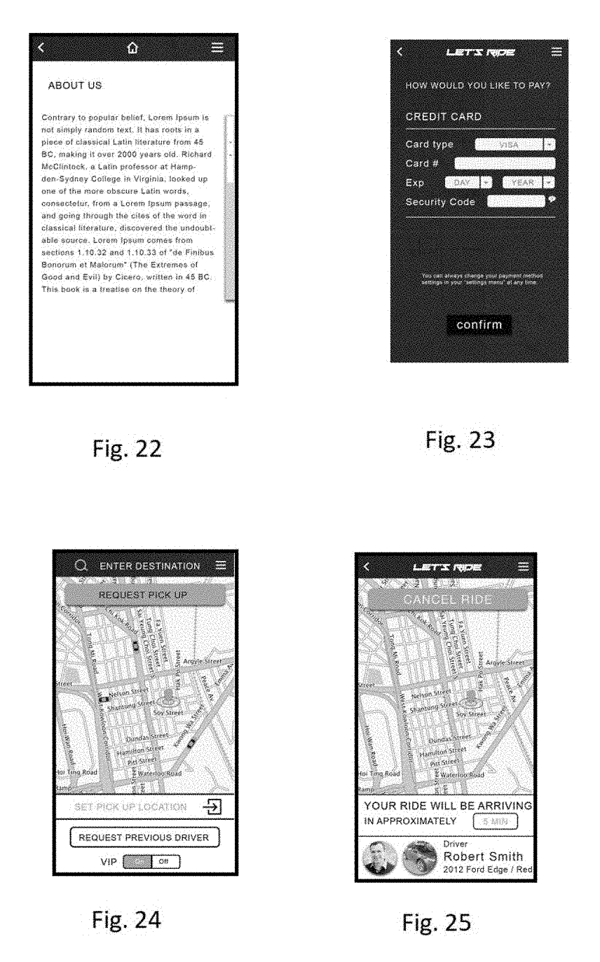

From the main menu, the user can access Setting (FIGS. 18 and 19), Notifications (FIG. 20), History (FIG. 21), Be a Passenger/Be a Driver sign-ups, Help), and About Us (FIG. 22).

From the main menu, passengers can access Payment (FIG. 23), and Promotions

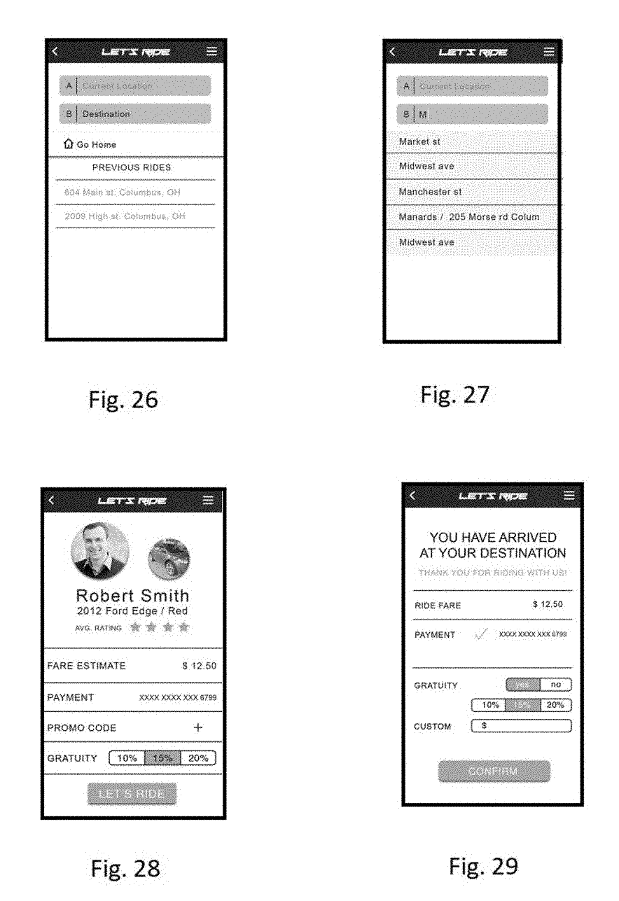

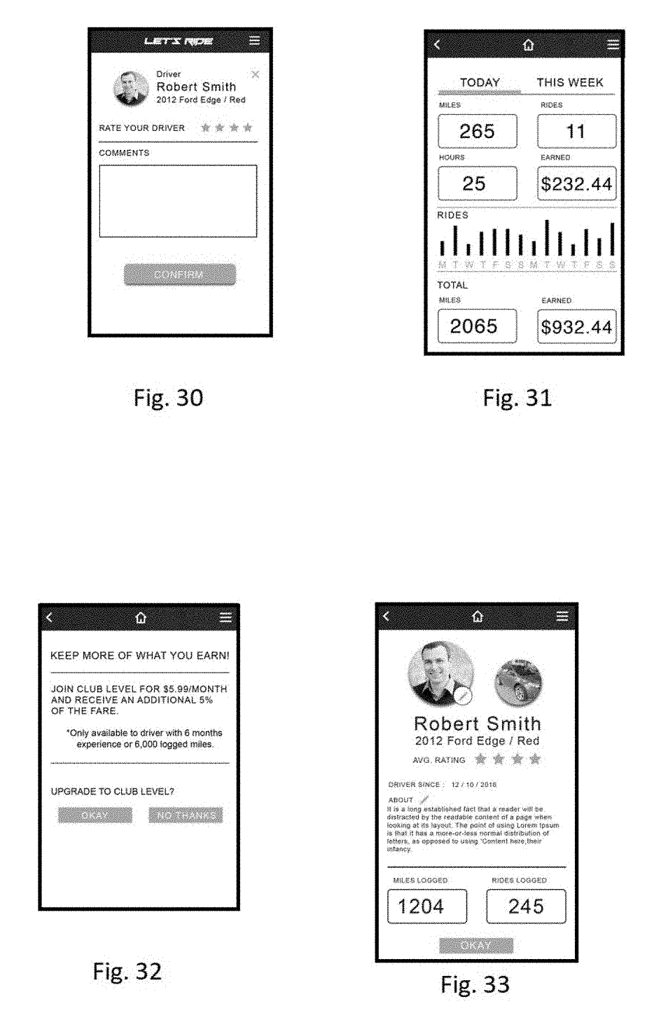

For a Passenger, from the Home screen (FIG. 24), the user can select VIP on/off and Request Pick Up. After requesting a pick up, the user will be shown the available driver and allow user to cancel pick up request (FIG. 25). User can then set a destination either by Previous Rides (FIG. 26) or entering a new destination (FIG. 27). When a driver and rider are matched, a fare estimate is provided. The user can choose to select a gratuity upfront and confirm the ride (FIG. 28). If a gratuity was not set upfront, the user can select a gratuity after the ride (FIG. 29). The user can then rate and leave comments for the driver (FIG. 30).

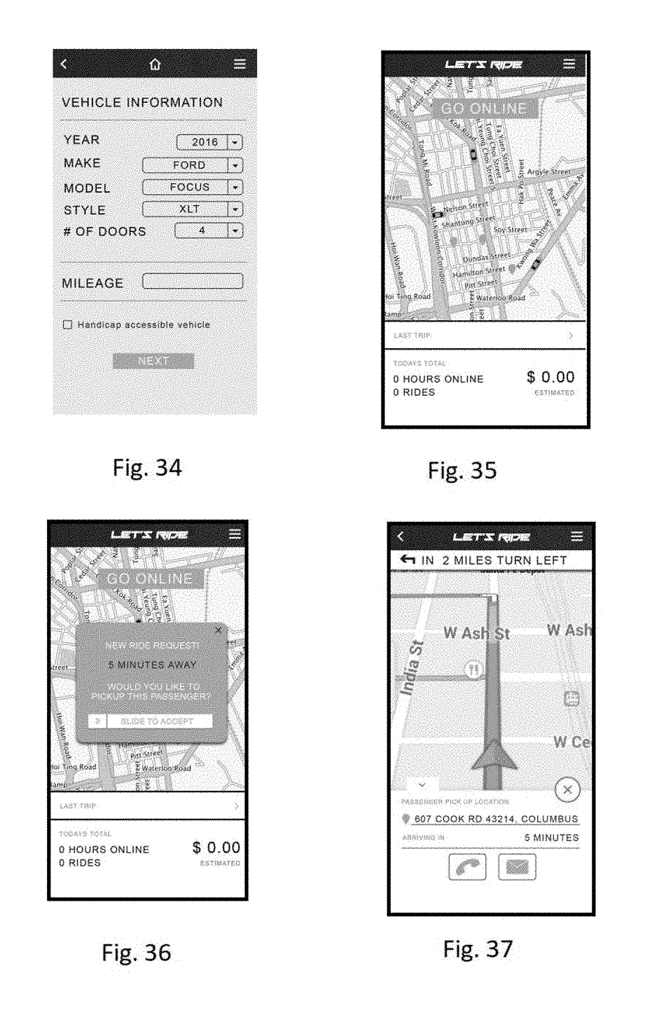

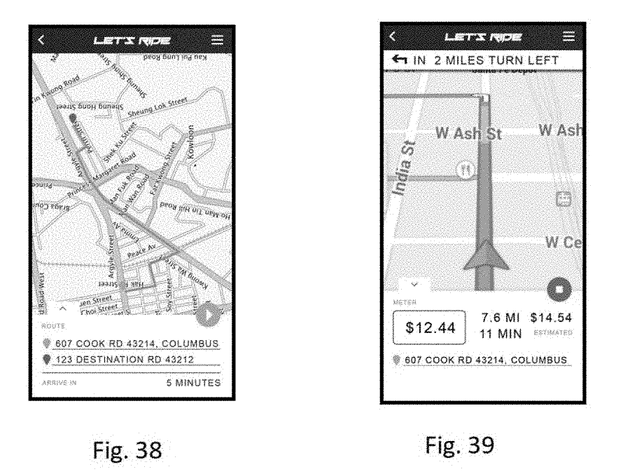

For a Driver, from the Home screen, the user can view account activity (FIG. 31), select to join Club Level (FIG. 32), view profile information (FIGS. 33 and 34). When the driver chooses to go active (FIG. 35), the user will be alerted when new rides are requested (FIG. 36). If the ride is selected, directions to pick up are provided (FIG. 37). After pick up, the route can be continued with GPS directions (FIG. 38) and with a visual meter (FIG. 39). The system 1 can off a pay as you go function for the Driver. The pay as you go feature allows the driver to get paid on their preferred schedule. They will have to drive a minimum number of hours to enable this feature.

Operation

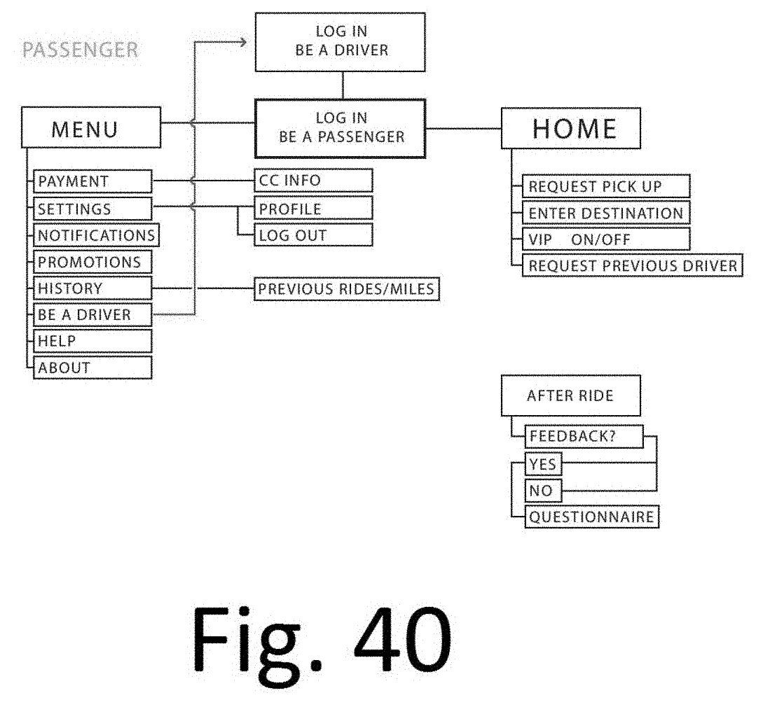

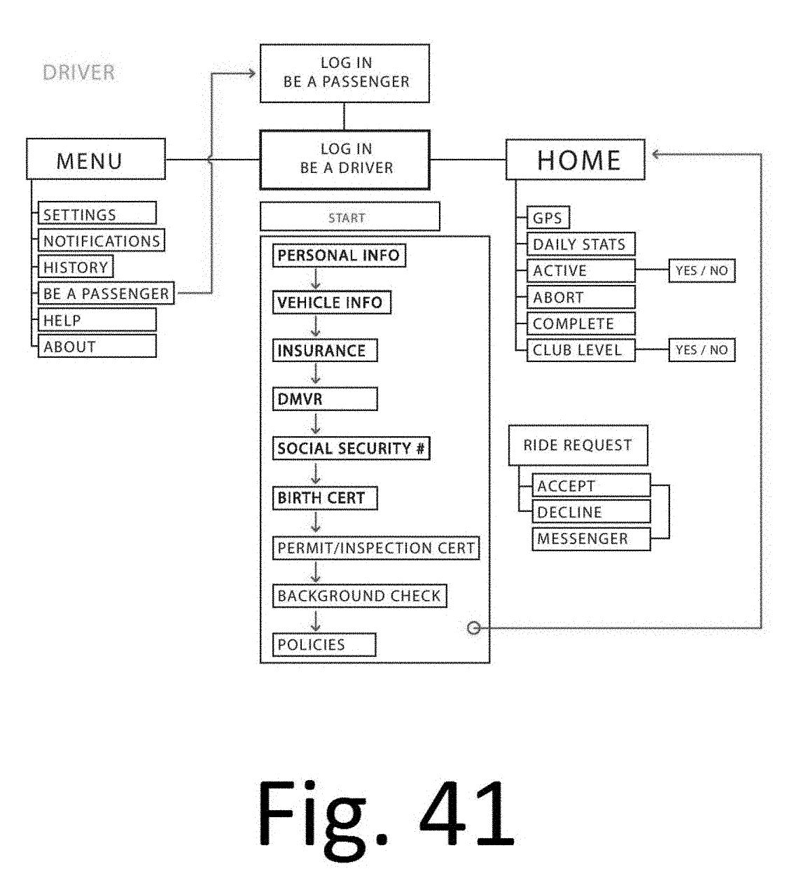

As shown in the flowcharts of FIGS. 40 and 41, the service user can post a desired fare and receive a private ride service or act as a ride provider and be matched with potential riders. When a fare is approved by both users, the driver picks up and drops off the rider.

The rider pays for the fare electronically through the app. After a ride is complete, each user can post a review of the other. With significant negative reviews, a user may be banned from the app.

### CONCLUSION

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising;
having a system that resides in the non-transitory memory of a computing device;
having a rider post a fare, having a driver review the fare, having a profile for the rider that the driver can review, having a profile for the driver that the rider can review, having the rider accept or reject the driver, having the driver accept or reject the rider, if accepted having the driver pick up and drive the rider after which the rider can write a review of the driver and the driver can write a review of the rider.

2. A system according to claim 1 having the driver charge a fair for the driving the rider.

3. A system according to claim 2 having the fair paid electrically.

4. A system according to claim 1 where the drivers and riders would sign-in directly or use social logins.

5. A system according to claim 1 where from a main menu, a user can access one or more of a set of Setting, Notifications, History, Be a Passenger sign-up, Be a Driver sign-ups, Help and About Us function.

6. A system according to claim 1 where a rider can access Payment, and Promotions functions.

7. A system according to claim 1 where after requesting a pick up, a rider will be shown the available driver and allow user to cancel pick up request.

8. A system according to claim 1 where a rider can set a destination either by Previous Rides or entering a new destination.

9. A system according to claim 1 where when a driver and rider are matched, a fare estimate is provided.

10. A system according to claim 1 where when a rider can choose to select a gratuity upfront and confirm the ride.

11. A system according to claim 1 where when a rider can select a gratuity.

12. A system according to claim 1 where a driver will be alerted when new rides are requested and if selected directions to rider are provided.

13. A system according to claim 1 where pick up, the route can be continued with GPS directions and with a visual meter.

14. A system according to claim 1 where a driver will be banned if they receive a set amount of negative reviews.

15. A system according to claim 1 where a rider will be banned if they receive a set amount of negative reviews.

16. A system according to claim 1 having a pay as you go function for the Driver.

17. A system according to claim 16 where the driver to get paid on their preferred schedule.

18. A system according to claim 16 where the driver will have to drive a minimum number of hours to access the pay as you go function.
